(19) United States
(12) Patent Application Publication
(10) Pub. No.: US 2014/0136090 A1
(43) Pub. Date: May 15, 2014

(54) VEHICLE TERMINAL APPARATUS AND METHOD FOR CONTROLLING THE SAME

(71) Applicant: Electronics and Telecommunications Research Institute, Daejeon (KR)

(72) Inventors: Hyun Jeong YUN, Daejeon (KR); Jeong Ah JANG, Daejeon (KR); Dong Yong KWAK, Daejeon (KR)

(73) Assignee: Electronics and Telecommunications Research Institute, Daejeon (KR)

(21) Appl. No.: 14/013,767

(22) Filed: Aug. 29, 2013

(30) Foreign Application Priority Data
Nov. 13, 2012 (KR) 10-2012-0128005

(51) Int. Cl. G08G 1/08

(52) U.S. Cl. CPC G08G 1/08
USPC 701/119; 701/117

(57) ABSTRACT

A vehicle terminal apparatus and method for controlling the apparatus that receives vehicle location information, registers a service based on service notification information subsequent to receiving the service notification information, and extracts traffic information based on the vehicle location information is provided.

### CROSS-REFERENCE TO RELATED APPLICATION

This application claims the priority benefit of Korean Patent Application No. 10-2012-0128005, filed on Nov. 13, 2012, in the Korean Intellectual Property Office, the disclosure of which is incorporated herein by reference.

### BACKGROUND

1. Field of the Invention

The present invention relates to a vehicle terminal apparatus for providing a traffic signal of an automatically guided cooperative vehicle-infrastructure (CVIS) system, and an apparatus for controlling a traffic signal.

2. Description of the Related Art

In general, a system for controlling a variable traffic signal may recognize a traffic flow, using a radio communication device based on a vehicular ad-hoc network, and ensure a smooth flow of traffic at a plurality of intersections by recognizing a volume of traffic flowing at the plurality of intersections and any associated congestion.

The system for controlling the variable traffic signal may analyze the volume of traffic via vehicular communication, and provide a traffic signal through interoperating with a roadside traffic light.

Also, a system for detecting a violation of traffic regulations may control a vehicle that neglects to adhere to a stop signal at an intersection and a crossroad, or a vehicle travelling in excess of a speed limit, using visible radio communication. The system may transmit a stop command signal, a departure command signal, and a speed information request signal to a vehicle to monitor a traffic signal violation of a vehicle, and receive, from the vehicle using a controller configured in a form of a master and slave relationship, a stop command response signal, a departure command response signal, and the speed request response signal, and subsequently process the same. Here, a slave controller may respond to the plurality of request signals, and use the visible communication between the master controller and a slave device.

A general system for providing a traffic signal may encode varied traffic signal information for a plurality of intersections based on road information, and transfer the traffic signal information to a vehicle via radio communication. The general system for providing the traffic signal may not control a signal based on a traffic flow depending on a signal controller, and may not provide information provided by a traffic control infrastructure to a vehicle.

### SUMMARY

An aspect of the present invention provides a vehicle terminal apparatus, including an interface to receive vehicle location information, a communication unit to receive service notification information from a traffic signal control apparatus, and a control unit to register a service based on the service notification information, and extract traffic information based on the vehicle location information.

The interface may receive vehicle speed information and vehicle steering angle information from a vehicle network.

The control unit may divide a service area, using the service notification information.

The control unit may extract a vehicle identifier, using the vehicle location information, and extract the traffic information on an accessible lane corresponding to the vehicle identifier.

The traffic information may include at least one of traffic signal information pertaining to an accessible lane, a traffic signal duration time of the accessible lane, and vehicle progress determination information of the accessible lane.

Another aspect of the present invention also provides an apparatus for controlling a traffic signal, the apparatus including an interface to receive a traffic signal from a signal controller on a lane, a communication unit to receive vehicle location information from a vehicle terminal apparatus, and a control unit to generate traffic information through analyzing the traffic signal, based on the vehicle location information.

The communication unit may transmit service notification information to the vehicle terminal apparatus, and receives service registration information from the vehicle terminal apparatus.

The control unit may generate a vehicle identifier for the vehicle terminal apparatus from which the service registration information is transmitted, and generates the traffic information corresponding to the vehicle identifier.

The control unit may generate the traffic information based on vehicle speed information received from the vehicle terminal apparatus, via the communication unit.

The traffic information may include a traffic light signal extracted based on the traffic signal, and a distance between the vehicle terminal apparatus and the signal controller, and a time for a vehicle to arrive at the signal controller based on the traffic speed information.

Still another aspect of the present invention also provides a method for controlling a vehicle terminal apparatus, the method including receiving vehicle location information via an interface, receiving service notification information from a traffic signal control apparatus via a communication unit, and registering a service based on the service notification information using a control unit, and extracting traffic information based on the vehicle location information.

Yet another aspect of the present invention also provides a method for controlling an apparatus for controlling a traffic signal, the method including receiving a traffic signal from a signal controller on a lane via an interface, receiving vehicle location information from a vehicle terminal apparatus via a communication unit, and generating, using a control unit, traffic information through analyzing the traffic signal based on the vehicle location information.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a vehicle terminal apparatus according to an embodiment of the present invention;

FIG. 2 is a block diagram illustrating a configuration of an apparatus for controlling a traffic signal according to an embodiment of the present invention;

FIG. 3 is a diagram illustrating an example of an apparatus for controlling a traffic signal installed at a non-signalized intersection;

FIG. 4 is a diagram illustrating an example of an apparatus for controlling a traffic signal installed at a signalized intersection;

FIG. 5 is a diagram illustrating an example of outputting a traffic signal of an accessible lane and a signal remaining time represented on a display unit of a vehicle terminal apparatus;

FIG. 6 is a flowchart illustrating a process of representing traffic information of a vehicle terminal apparatus according to an aspect of an embodiment of the present invention;

FIG. 7 is a diagram illustrating a traffic signal transferred to traffic information according to an aspect of an embodiment of the present invention; and

FIG. 8 is a diagram illustrating an example of selecting service notification information received continuously at a point at which a communication range in an area adjacent to an intersection overlaps according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

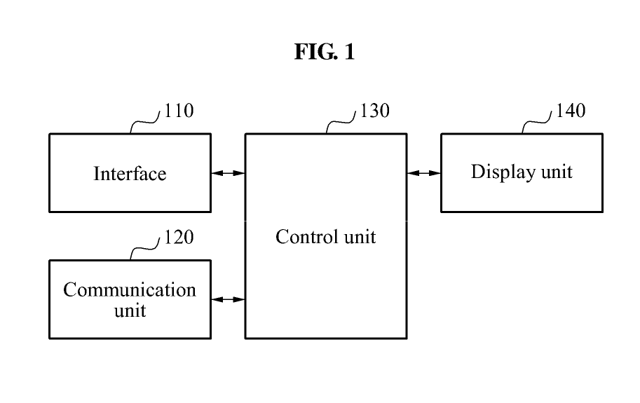

FIG. 1 is a block diagram illustrating a configuration of a vehicle terminal apparatus according to an embodiment of the present invention.

Referring to FIG. 1, the vehicle terminal apparatus may include an interface 110 to receive vehicle location information, a communication unit 120 to receive service notification information from an apparatus for controlling a traffic signal, and a control unit 130 to register a service based on the service notification information, and extract traffic information based on the vehicle location information.

The interface 110 may receive vehicle speed information and vehicle steering angle information from a vehicle network.

The interface 110 may receive an input of location data from a global positioning system (GPS) or a real time kinematic (RTK) device to transfer the location data to the control unit 130, and receive information about a speed, a steering angle, and the like, of a vehicle to be transferred to the control unit 130 through being connected to a vehicle network, for example, a controller area network (CAN).

The control unit 130 may divide a service area, using the service notification information.

The control unit 130 may extract a vehicle identifier using the vehicle location information, and extract traffic information pertaining to an accessible lane corresponding to the vehicle identifier.

The control unit 130 may divide the service area through a service notification message received from the apparatus for controlling the traffic signal, and transfer the vehicle location information to the apparatus for controlling the traffic signal periodically, subsequent to registration. Also, the control unit 130 may receive the traffic information from the apparatus for controlling the traffic signal, and then extract a traffic signal of the accessible lane by extracting a link identification (ID) via the vehicle location information.

Here, the traffic information may include at least one of the traffic signal information pertaining to an accessible lane, a traffic signal duration time of the accessible lane, and vehicle progress determination information pertaining to the accessible lane.

The vehicle terminal apparatus may further include a display unit 140, and display a message of traffic information, alert information, and the like, received from the apparatus for controlling the traffic signal.

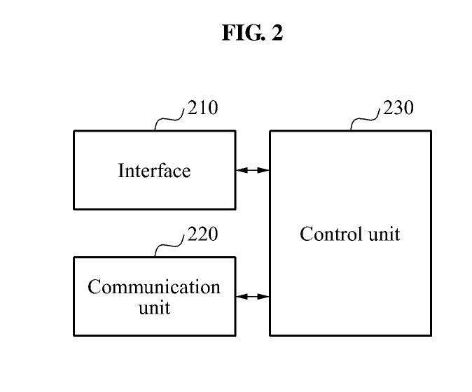

FIG. 2 is a block diagram illustrating a configuration of an apparatus for controlling a traffic signal according to an embodiment of the present invention.

Referring to FIG. 2, the apparatus for controlling the traffic signal may include an interface 210 to receive a traffic signal from a signal controller of a lane, a communication unit 220 to receive vehicle location information from a vehicle terminal apparatus, and a control unit 230 to generate traffic information by analyzing a traffic signal based on the traffic location information.

According to an aspect of the present invention, the communication unit 220 may transmit service notification information to the vehicle terminal apparatus, and receive service registration information from the vehicle terminal apparatus.

According to an aspect of the present invention, the control unit 230 may generate a vehicle identifier for the vehicle terminal apparatus from which the service registration information is transmitted, and generate traffic information corresponding to the vehicle identifier.

According to an aspect of the present invention, the control unit 230 may generate traffic information based on vehicle speed information received via the communication unit 220 from the vehicle terminal apparatus.

According to an aspect of the present invention, the traffic information may include a traffic light signal extracted based on the traffic signal, a distance between the vehicle terminal apparatus and the signal controller, and a remaining time until a vehicle arrives at the signal controller based on the vehicle speed information.

The apparatus for controlling the traffic signal may receive traffic information pertaining to a traffic signal, a road sign, an obstacle, weather information, and the like. Also, the apparatus for controlling the traffic signal may estimate a volume of traffic, using location information of the vehicle terminal apparatus registered in a service, and transfer the estimated traffic information to the vehicle terminal apparatus via the communication unit 220.

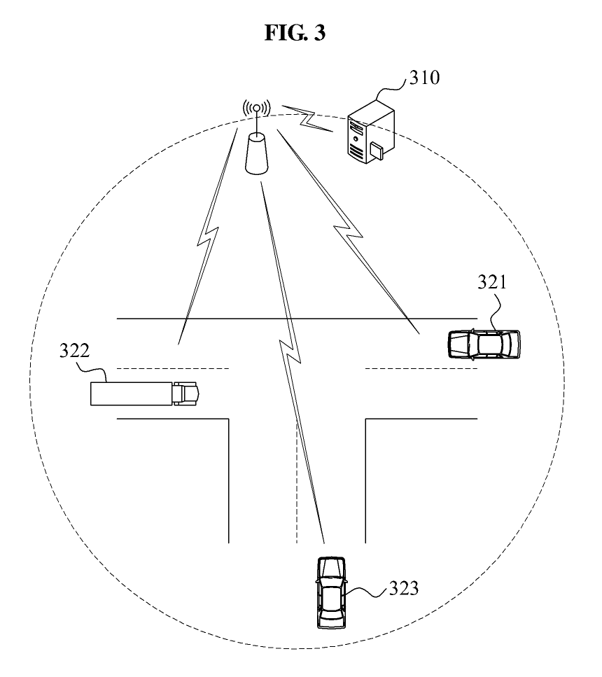

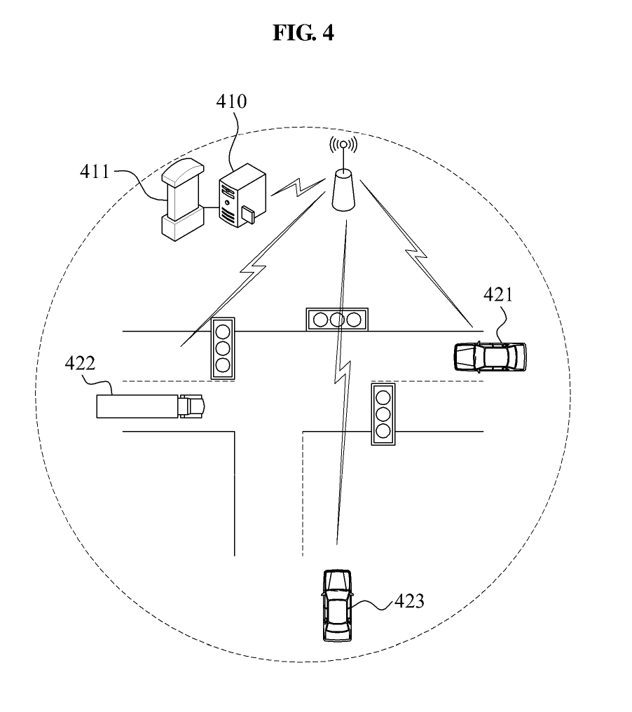

FIG. 3 is a diagram illustrating an example of an apparatus 310 for controlling a traffic signal installed at a non-signalized intersection, and FIG. 4 is a diagram illustrating an example of an apparatus 410 for controlling a traffic signal installed at a signalized intersection.

Although FIGS. 3 and 4 illustrate an example in which the apparatuses 310 and 410 for controlling the traffic signal are applied to a three-stop intersection, the apparatuses 310 and 410 for controlling the traffic signal are not limited thereby and are applicable to various intersections.

Referring to FIG. 3, vehicle terminal apparatuses 321 to 323 may be mounted on vehicles at a non-signalized intersection, and the apparatus for controlling the traffic signal 310 to which an apparatus able to communicate with the vehicle terminal apparatuses 321 to 323 is connected may be disposed on a road side, such that a combination of the apparatuses for controlling the traffic signal and the vehicle terminal apparatus, for example, apparatuses 310 and 321, apparatuses 310 and 322, and apparatuses 310 and 323, may transmit and receive data via radio communication.

Referring to FIG. 4, a signal controller 411 on which a time controller for controlling a time interval assigned to a single or a plurality of flows simultaneously receiving a right of way traffic signal at a signalized intersection and the apparatus 410 for controlling the traffic signal are connected, and the apparatus 410 for controlling the traffic signal may receive data from the signal controller 411, and transfer the data to vehicles on which vehicle terminal apparatuses 421, 422, and 423 are installed.

A driver may recognize a traffic signal through one of the vehicle terminal apparatuses 421, 422, and 423, rather than through a signal lamp, and make efficient use of a corresponding traffic signal when the signal lamp is in an unsteady state or fails to operate due to a natural disaster.

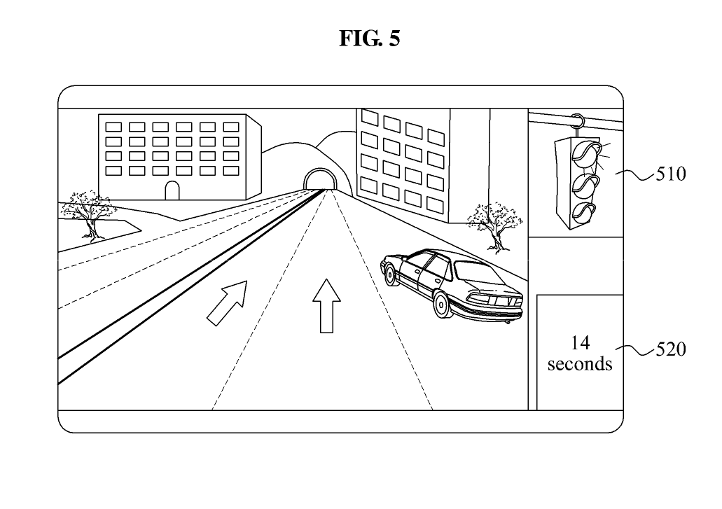

FIG. 5 is a diagram illustrating an example of outputting a traffic signal 510 of an accessible lane and a signal remaining time 520 represented on a display unit of a vehicle terminal apparatus.

Referring to FIG. 5, a driver may verify the traffic signal 510 and the signal remaining time 520 via the display unit of the vehicle terminal apparatus. For example, when a signal is obscured due to a large truck in front of a vehicle of the driver, the driver may verify a condition of an intersection ahead via the information represented via the display unit.

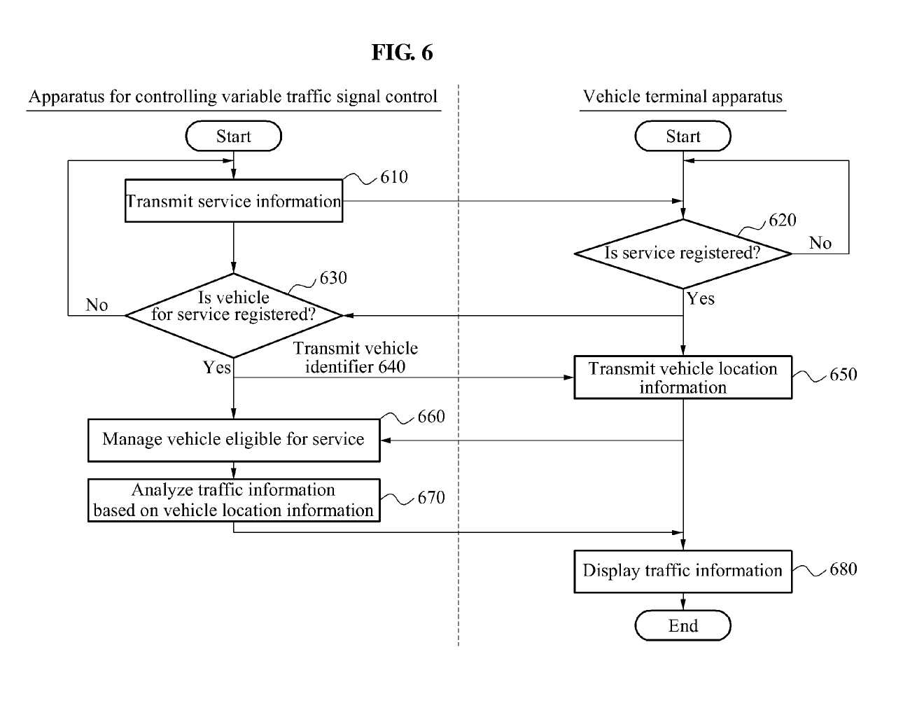

FIG. 6 is a flowchart illustrating a process of representing traffic information of a vehicle terminal apparatus according to an aspect of an embodiment of the present invention.

Referring to FIG. 6, the vehicle terminal apparatus may download a service map to initiate a service. Here, the service map may be embedded in a map download server and the vehicle terminal apparatus. The service map may include network information on a link system for each accessible lane based on a geometric structure of an intersection. For example, a point at which an intersection and a lane of the service map cross may have a common node-link system based on a standard node-link system from the Department of Transportation (DOT).

In operation 610, an apparatus for controlling a traffic signal may transmit service notification information periodically when a service commences. Here, the service notification information may include a type of a service, an identifier of the apparatus for controlling the traffic signal, intersection center point node location information, service area safety speed information, and the like.

The vehicle terminal apparatus may determine whether a service is registered in operation 620, and when the service commences, may request the service to be registered through transmitting the service registration information to the apparatus for controlling the traffic signal.

For example, the vehicle terminal apparatus may register a type of a service and a type of a vehicle through transmitting the service registration information to the apparatus for controlling the traffic signal. Here, the apparatus for controlling the traffic signal may determine the type of the vehicle, such as, a priority, for example, an emergency rescue vehicle.

The apparatus for controlling the traffic signal may determine whether the vehicle terminal apparatus from which the service registration information is transmitted is registered in a vehicle eligible for a service in operation 630, and when registration is required, the vehicle eligible for the service may be registered in a database (DB). In operation 640, a vehicle identifier available in a service area may be generated to be transmitted to the vehicle terminal apparatus.

In operation 650, the vehicle terminal apparatus to which the vehicle identifier is assigned may transmit location information of the vehicle terminal apparatus to the apparatus for controlling the traffic signal periodically to be provided with traffic information. In this instance, the vehicle terminal apparatus may not transmit a vehicle identification number (VIN) through which a vehicle is identified to protect personal information. Also, the apparatus for controlling the traffic signal may securely manage personal location information because the vehicle identifier assigned by the apparatus for controlling the traffic signal and the location information received are managed through being mapped.

In operation 660, the apparatus for controlling the traffic signal may manage the vehicle eligible for the service based on the information received from the vehicle terminal apparatus. In operation 670, the apparatus for controlling the traffic signal may alternate an analysis of the traffic information through analyzing a number and location of vehicles in an intersection service area.

For example, the apparatus for controlling the traffic signal may transmit input data to the signal controller, using the location information, and when a vehicle is absent in a corresponding lane, may change a traffic signal.

The apparatus for controlling the traffic signal may transmit the traffic information to an individual vehicle, and transmit the traffic information to vehicles in all lanes. For example, the apparatus for controlling the traffic signal may transmit the traffic information to an individual vehicle in an area with a low volume of traffic, and may transmit the traffic information to all lanes for the traffic information to be displayed via the vehicle terminal apparatus.

The apparatus for controlling the traffic signal may transmit information such as traffic light information, a vehicle identifier, whether to proceed at an intersection, a signal duration time, and the like, to the vehicle terminal apparatus. The vehicle terminal apparatus may display the traffic light information by receiving the information, and utilize the information for determining whether a manned or an unmanned vehicle enters an intersection. Also, the vehicle terminal apparatus may provide a location of the vehicle terminal apparatus on a service map when the apparatus for controlling the traffic signal transmits the traffic information to all vehicles in a service area.

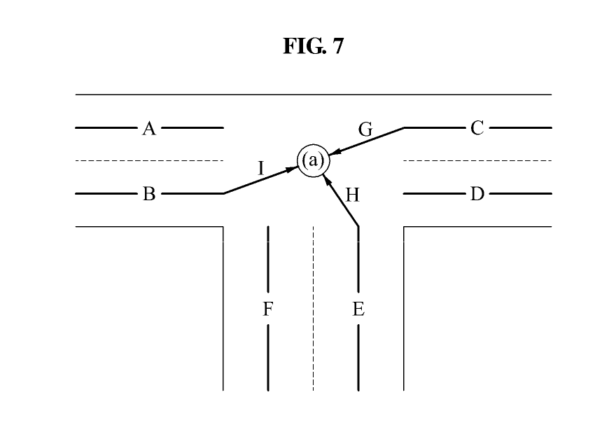

FIG. 7 is a diagram illustrating a traffic signal transferred to traffic information according to an aspect of an embodiment of the present invention, and Table 1 is an example of intersection signal information for each lane.

Referring to FIG. 7 and Table 1, the apparatus for controlling the traffic signal may map traffic signal information (a), such as a traffic signal received from the signal controller or a traffic signal generated through an algorithm of the apparatus for controlling the traffic signal and link identifiers A, B, C, D, E, F, G, H, and I displayed on a map of a service area. Also, the apparatus for controlling the traffic signal may transmit the mapped information to each vehicle terminal apparatus through dividing the mapped information for each vehicle.

TABLE 1

| | | | Proceed | | | |
|---|---|---|---|---|---|---|
| | | Pe- | with | Left- | | |
| Node | Link | destrian | caution | turn | Special | Remaining |
| identifier | identifier | signal | signal | signal | signal | signal time |
| (a) | B | 00 | 01 | 10 | 11 | 30 seconds |
| | | | | | | (sec) |
| (a) | C | 00 | 01 | 10 | 11 | 25 sec |
| (a) | E | 00 | 01 | 10 | 11 | 30 sec |

The vehicle terminal apparatus may match the location information of the vehicle terminal apparatus with the service map, and output a traffic signal to a display unit through extracting a node identifier/link identifier in a direction in which a vehicle is proceeding.

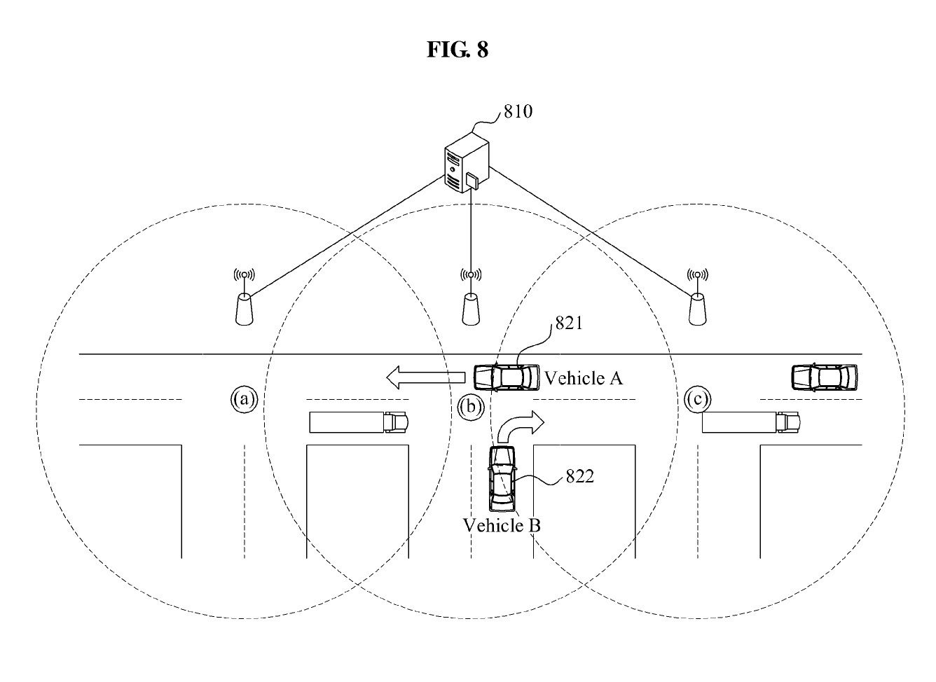

FIG. 8 is a diagram illustrating an example of selecting service notification information received continuously at a point at which a communication range in an area adjacent to an intersection overlaps according to an embodiment of the present invention.

Referring to FIG. 5, a vehicle B 822 may receive the service notification information transmitted from an apparatus 810 for controlling a traffic signal from both of an intersection node (b) or an intersection node (c). In this instance, the vehicle B 822 may compare a node and link system information through verifying vehicle location information, and divide the service notification information through determining a link identifier of a corresponding accessible lane and an intersection node over a minimum period of time. Also, a vehicle A 821 may divide the service notification information through determining a link identifier of a corresponding accessible lane and an intersection node over a minimum period of time.

According to the present exemplary embodiment, it is possible to generate a variable traffic signal, using vehicle location information, and provide signal information to a vehicle terminal apparatus at a non-signalized intersection without a traffic light.

According to the present exemplary embodiment, it is possible to provide traffic signal information to a vehicle terminal apparatus, using radio communication between a vehicle and an infrastructure due to difficulty in recognizing a traffic light at an intersection in a case of an autonomous unmanned vehicle.

According to the present exemplary embodiment, it is possible to provide to a vehicle terminal apparatus through generating a traffic signal based on a number of vehicles in an intersection area, location information, and a vehicle speed at a non-signalized intersection.

According to the present exemplary embodiment, it is possible to regulate, at an intersection, vehicular accidents and vehicles exceeding a speed limit, for example, transferring a warning through tracing a violating vehicle based on vehicle location information registered in an apparatus for controlling a traffic signal.

An apparatus for controlling a traffic signal according to an aspect of the present invention may transmit a service notification message to a vehicle terminal apparatus through broadcasting, using a radio communication device, and the vehicle terminal apparatus receiving the service notification message may transfer vehicle location information periodically to the apparatus for controlling the traffic signal through requesting a service to be registered and being assigned a vehicle identifier.

The apparatus for controlling the traffic signal may transfer traffic signal information generated for each link based on location information received from a vehicle terminal apparatus and a signal remaining time to the vehicle terminal apparatus, and the vehicle terminal apparatus may determine whether to proceed at an intersection, based on a proceeding direction and network information, for example, a node/link system, of a service map.

The apparatus for controlling the traffic signal may extract vehicle speed information through tracing a satellite time and a coordinate of a vehicle, and transfer warning information to the vehicle terminal apparatus when the vehicle violates a safety speed within an intersection.

According to the present exemplary embodiment, it is possible to provide a system for providing variable traffic signal information, using radio communication to a vehicle terminal apparatus in an intersection area.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A vehicle terminal apparatus, comprising:
an interface to receive vehicle location information;
a communication unit to receive service notification information from a traffic signal control apparatus; and
a control unit to register a service based on the service notification information, and extract traffic information based on the vehicle location information.

2. The vehicle terminal apparatus of claim 1, wherein the interface receives vehicle speed information and vehicle steering angle information from a vehicle network.

3. The vehicle terminal apparatus of claim 1, wherein the control unit divides a service area, using the service notification information.

4. The vehicle terminal apparatus of claim 1, wherein the control unit extracts a vehicle identifier, using the vehicle location information, and extracts the traffic information on an accessible lane corresponding to the vehicle identifier.

5. The vehicle terminal apparatus of claim 1, wherein the traffic information comprises at least one of:
traffic signal information pertaining to an accessible lane, a traffic signal duration time of the accessible lane, and vehicle progress determination information of the accessible lane.

6. An apparatus for controlling a traffic signal, the apparatus comprising:
an interface to receive a traffic signal from a signal controller on a lane;
a communication unit to receive vehicle location information from a vehicle terminal apparatus; and
a control unit to generate traffic information through analyzing the traffic signal, based on the vehicle location information.

7. The apparatus of claim 6, wherein the communication unit transmits service notification information to the vehicle terminal apparatus, and receives service registration information from the vehicle terminal apparatus.

8. The apparatus of claim 7, wherein the control unit generates a vehicle identifier for the vehicle terminal apparatus from which the service registration information is transmitted, and generates the traffic information corresponding to the vehicle identifier.

9. The apparatus of claim 6, wherein the control unit generates the traffic information based on vehicle speed information received from the vehicle terminal apparatus, via the communication unit.

10. The apparatus of claim 9, wherein the traffic information comprises:
a traffic light signal extracted based on the traffic signal; and
a distance between the vehicle terminal apparatus and the signal controller, and a time for a vehicle to arrive at the signal controller based on the traffic speed information.

11. A method for controlling a vehicle terminal apparatus, the method comprising:
receiving vehicle location information via an interface;
receiving service notification information from a traffic signal control apparatus via a communication unit; and
registering a service based on the service notification information using a control unit, and extracting traffic information based on the vehicle location information.

12. The method of claim 11, further comprising:
receiving vehicle speed information and vehicle steering angle information from a vehicle network via the interface.

13. The method of claim 11, further comprising dividing, through the control unit, a service area using the service notification information.

14. The method of claim 11, further comprising:
extracting a vehicle identifier using the vehicle location information; and
extracting the traffic information on an accessible lane corresponding to the vehicle identifier.

15. The method of claim 11, wherein the traffic information comprises at least one of:
traffic signal information pertaining to an accessible lane, a traffic signal duration time of the accessible lane, and vehicle progress determination information of the accessible lane.

16. A method for controlling an apparatus for controlling a traffic signal, the method comprising:
receiving a traffic signal from a signal controller on a lane via an interface;
receiving vehicle location information from a vehicle terminal apparatus via a communication unit; and
generating, using a control unit, traffic information through analyzing the traffic signal based on the vehicle location information.

17. The method of claim 16, further comprising:
transmitting service notification information to the vehicle terminal apparatus via the communication unit; and
receiving service registration information from the vehicle terminal apparatus via the communication unit.

18. The method of claim 17, further comprising:
generating a vehicle identifier for the vehicle terminal apparatus from which the service registration information is transmitted using the control unit; and
generating the traffic information corresponding to the vehicle identifier, using the control unit.

19. The method of claim 16, further comprising:
generating, using the control unit, the traffic information based on vehicle speed information received via the communication unit from the vehicle terminal apparatus.

20. The method of claim 19, wherein the traffic information comprises:
a traffic light signal extracted based on the traffic signal; and
a distance between the vehicle terminal apparatus and the signal controller, and a time for a vehicle to arrive at the signal controller based on the traffic speed information.
